(19) United States
(12) Patent Application Publication
(10) Pub. No.: US 2026/0002713 A1
(43) Pub. Date: Jan. 1, 2026

(54) Proportional Valve Arrangement

(71) Applicant: ECO Holding 1 GmbH, Marktheidenfeld (DE)

(72) Inventors: Matthias Gräfensteiner, Oberasbach (DE); Hartmut Weber, Altdorf (DE)

(73) Assignee: ECO Holding 1 GmbH, Marktheidenfeld (DE)

(21) Appl. No.: 19/250,510

(22) Filed: Jun. 26, 2025

(30) Foreign Application Priority Data
Jun. 28, 2024 (DE) 10 2024 118 411.6

(51) Int. Cl. F25B 41/20; F16K 11/044

(52) U.S. Cl. CPC F25B 41/20; F16K 11/044

(57) ABSTRACT

A proportional valve arrangement for refrigerant includes a valve body chamber having an inflow opening, a first outflow opening and a second outflow opening. Furthermore, the proportional valve arrangement includes a valve body which is designed to be transferable in the valve body chamber in a longitudinal axis direction between a first sealing seat and a second sealing seat, wherein the valve body opens a first flow path from the inflow opening to the first outflow opening when the valve body bears against the first sealing seat, and opens a second flow path from the inflow opening to the second outflow opening when the valve body bears against the second sealing seat.

### CROSS-REFERENCE TO RELATED APPLICATIONS

The present application claims priority from German Application No. 10 2024 118 411.6 filed Jun. 28, 2024, the disclosure of which is hereby incorporated herein by reference.

### FIELD OF THE INVENTION

The invention relates to a proportional valve arrangement for refrigerant comprising a valve body chamber comprising an inflow opening, a first outflow opening and a second outflow opening. Furthermore, the proportional valve arrangement comprises a valve body which is designed to be transferable in the valve body chamber in a longitudinal axis direction between a first sealing seat and a second sealing seat, wherein the valve body opens a first flow path from the inflow opening to the first outflow opening when the valve body bears against the first sealing seat, and opens a second flow path from the inflow opening to the second outflow opening when the valve body bears against the second sealing seat.

### BACKGROUND OF THE INVENTION

Such proportional valve arrangements are used, for example, for fluid systems of at least partially electrically operated motor vehicles. Such proportional valves are also referred to as continuous valves or directional valves, on which, in the field of motor vehicles at least, high demands are set. For example, fluids can be present in the liquid or gaseous state of aggregation. In addition, very high internal tightness requirements apply in both the liquid and gaseous state of the fluid. These tightness requirements also apply to the outside. As a consequence, the proportional valve arrangement must meet boundary conditions such that no pressure-relieved connection prevails at the valve and that no reliable pressure reduction can take place.

In the case of large pressure differences, large hydraulic or pneumatic forces acting axially on the piston frequently occur in valves. As a result, it is necessary that large actuating forces are required to actuate the valves. This usually takes place by means of drives of corresponding size at corresponding costs.

A further challenge in this case is to ensure the tightness of the valve arrangement.

### BRIEF SUMMARY OF THE INVENTION

An aspect of the invention may provide a valve arrangement which belongs to the technical field mentioned at the outset and which at least partially overcomes the disadvantages from the prior art. In particular, an aspect of the invention relates to a valve arrangement which takes account of the high tightness requirements. In particular, an aspect of the invention may provide protection of the sealing means of the valve arrangement against failure, in particular in the case of large pressure differences.

An embodiment of the invention relates to a proportional valve arrangement for refrigerant comprising a valve body chamber comprising an inflow opening, a first outflow opening and a second outflow opening. Furthermore, the proportional valve arrangement comprises a valve body which is designed to be transferable in the valve body chamber in a longitudinal axis direction between a first sealing seat and a second sealing seat, wherein the valve body opens a first flow path from the inflow opening to the first outflow opening when the valve body bears against the first sealing seat, and opens a second flow path from the inflow opening to the second outflow opening when the valve body bears against the second sealing seat. The valve body comprises a first sealing means which is designed to bear against the first sealing seat, and a second sealing means which is designed to bear against the second sealing seat.

Valves generally serve to block and/or control the throughflow of a fluid. Simpler valves can only be controlled discretely. This means that they can only be switched on/off, that is to say that they can only be opened and closed. However, a simple opening and closing of the valve is no longer sufficient for many applications. For example, the use as an expansion valve which is implemented in a battery cooling, air conditioning or heat pump system in order to generate there a defined and controllable pressure drop between condenser (heat output) and evaporator (heat absorption) often requires a more continuous switching. Overall, a continuous switching is therefore frequently required. Such a continuous or steady switching can take place, for example, by means of proportional valves which allow a steady transition of the switching positions. The volume flow of the fluid can thus be set. Such proportional valves therefore not only allow discrete switching positions with the aid of a drive, but allow a steady transition of the valve opening.

A refrigerant in the sense of the invention is to be understood as a fluid which is used for heat transfer in a refrigeration system and which absorbs heat at low temperature and low pressure and outputs heat at higher temperature and higher pressure, wherein state changes of the fluid usually take place.

This results, for example, in the technical advantage that the proportional valve arrangement can precisely assume any position of the valve body between the first sealing seat and the second sealing seat. This results in the further advantage that the proportional valve arrangement can be switched continuously and the volume flow can be controlled exactly. For example, the valve body can be moved variably between the first sealing seat and the second sealing seat, as a result of which the first flow path and the second flow path are opened at the same time. The more the valve body moves in the direction of the first sealing seat, the smaller the flow cross section of the second flow path and the larger the flow cross section of the first flow path. The more the valve body moves in the direction of the second sealing seat, the smaller the flow cross section of the first flow path and the larger the flow cross section of the second flow path. In a central position, the valve body is located at the same distance from the first sealing seat and from the second sealing seat. In this position, the first flow cross section and the second flow cross section are of equal size.

A further technical advantage results from the fact that an associated sealing means is provided in each case both for the first sealing seat and for the second sealing seat. The sealing means can be produced, for example, from elastic materials, as a result of which better sealing takes place in the abutment against the first sealing seat or the second sealing seat. In this respect, according to the invention, a combination of a continuously switchable proportional valve arrangement with a particularly adaptable sealing behavior results on account of the first sealing seat, to which the first sealing means is assigned, and the second sealing seat, to which the second sealing means is assigned.

According to a preferred embodiment, the first sealing means and the second sealing means each comprise or consist of plastic, in particular an elastomer. This results, for example, in the technical advantage that the tightness of the proportional valve arrangement can be influenced directly by the targeted selection of the plastic for the first sealing means and the second sealing means. The softer the plastic, the more both the first sealing means and the second sealing means can deform in the abutment against the first sealing seat and the second sealing seat, and can adapt to the latter. As a result, a specific adaptation to the tightness of the proportional valve arrangement can be undertaken as a function of the fluid, the pressure and the temperature.

According to a further preferred embodiment, the first sealing means comprises a first section which is designed for abutment against the first sealing seat. This achieves, for example, the technical advantage that the first section of the first sealing means can adapt geometrically to the first sealing seat. For example, an inclined surface can be formed in the region of the first section, as a result of which optimum sealing of the first sealing seat can be realized. At the same time, the frustoconical surface of the first section of the first sealing means produces a self-centering function when the first section of the first sealing means enters the first sealing seat.

According to an additional embodiment, the second sealing means comprises a first section which is designed for abutment against the second sealing seat. This makes it possible, analogously to the technical advantages of the first sealing means, for the first section of the second sealing seat to adapt geometrically to the second sealing seat. For example, an inclined surface is formed in the region of the first section of the second sealing means, as a result of which optimum sealing of the second sealing seat can be realized. At the same time, the frustoconical surface of the first section of the second sealing means produces a self-centering function when the first section of the second sealing means enters the second sealing seat.

According to a particularly advantageous embodiment, the first sealing means and the second sealing means are each arranged tensioned in the longitudinal axis direction. This results, for example, in the technical advantage that the hardness of the sealing means and the prestressing thereof can be influenced in a targeted manner by the axial tensioning of the first sealing means and of the second sealing means, in order thus to adapt the surface hardness of the first section of the respective first sealing means and of the second sealing means to the circumstances.

According to a particularly preferred embodiment, the valve body comprises a first holding means and a second holding means, wherein the first sealing means and the second sealing means are arranged in the longitudinal axis direction between the first holding means and the second holding means. The exact position of the first sealing means and of the second sealing means can be ensured by the arrangement of the first holding means and of the second holding means. In addition, an additional control of, for example, an elastic first sealing means and of an elastic second sealing means can be exerted via the axial position of the first holding means and of the second holding means. Overall, this results in the technical advantage that, on the one hand, a soft elastic material—for example a soft plastic or a soft elastomer—can be selected as first sealing means and as second sealing means. In addition, a high tightness of the proportional valve arrangement can be ensured by the use of the first holding means and of the second holding means even in the case of a high fluid pressure and large temperature differences, wherein the tension state of the sealing means can be controlled by the position of the holding means. An optimum combination of advantages of tightness and control of the hardness of the elastic sealing means by the first holding element and the second holding element is produced. In addition, this advantage is combined with the known continuously controllable positioning of the proportional valve arrangement.

In order to additionally increase the adaptability of the proportional valve arrangement, the first holding means and/or the second holding means is designed to be displaceable in the longitudinal axis direction. This achieves, for example, the technical advantage that at least one holding means, either the first holding means or the second holding means, or the first holding means and the second holding means can be moved or adapted in the longitudinal axis direction, which in turn makes it possible to vary the extent of the tensioning of the first sealing means and of the second sealing means. As a result, an adaptation of the proportional valve arrangement to a specific fluid can take place as a function of the boundary conditions such as fluid pressure or the temperature.

According to a further particularly advantageous embodiment, a spacer means is arranged between the first sealing means and the second sealing means, which spacer means is designed to stop the valve body against the first sealing seat and the second sealing seat. In other words, when the valve body with the first sealing means is transferred into the first valve seat, the spacer means comes into contact with a section of the first sealing seat. In this contact state, the first sealing means bears sealingly against a further section of the first sealing seat, with the result that the second flow path is closed. Correspondingly, the spacer means comes into contact with a section of the second sealing seat when the valve body with the second sealing means is transferred into the second sealing seat. In this contact state, the second sealing means bears sealingly against a further section of the second sealing seat, with the result that the first flow path is closed. The spacer means therefore serves at the same time to stabilize the first sealing means and the second sealing means and to limit the movement of the valve body between the first sealing seat and the second sealing seat. In other words, the respective closing force is introduced at least partially via the spacer means, and not completely via the first or second sealing means, into the associated first or second sealing seat and is absorbed by the first or second sealing seat. This ensures, on the one hand, that the tightness of the proportional valve arrangement is reliably achieved and ensured both with respect to the first sealing seat and with respect to the second sealing seat. On the other hand, it is at the same time achieved that both the first sealing means and the second sealing means can be protected against overloading, since the spacer means limits the stroke of the valve body. More precisely, the first sealing means and the second sealing means can be prevented from undergoing a plastic deformation or shearing off of sections of the first or second sealing means, since the spacer means can also reliably dissipate high forces, which otherwise act directly on the first or second sealing means and would press the latter further into the corresponding first or second sealing seat, into the first or second sealing seat. It is thereby possible to prevent the first or second sealing means from being squeezed or sheared off owing to the acting forces, and therefore failing. As a result, the tightness of the proportional valve arrangement can be reliably met and the service life thereof can be improved.

According to a particularly advantageous embodiment, the first sealing means and the second sealing means are designed as a one-piece integral sealing means. This achieves, for example, the technical advantage that the number of components used can be reduced. For example, the first sealing means and the second sealing means can be produced as a one-piece integral sealing means, as a result of which the production costs are reduced and the assembly outlay is simplified. In particular, the one-piece integral sealing means can be produced by injection-molding the spacer means, such that the first sealing means and the second sealing means of the one-piece integral sealing means are spaced apart from one another by means of the spacer means, but are integrally connected to one another.

Preferably, the one-piece integral sealing means is U-shaped when considered in a cross-sectional view. This achieves, for example, the technical advantage that in each case one leg of the U-shaped integral sealing means can form the first sealing element and the second sealing element. In particular, the spacer means between the legs of the U-shaped integral sealing means can ensure additional stabilization of the sealing means. As a result, the arrangement of the sealing means in combination with the spacer element in the center between the U-shaped legs of the sealing means, and advantageously as a result of the tensioning by means of the first holding means and the second holding means, achieves optimum tightness of the proportional valve arrangement both with respect to the first sealing seat and with respect to the second sealing seat.

According to a further preferred embodiment of the proportional valve arrangement, the spacer means comprises a stopper which projects beyond the first sealing means and the second sealing means in a direction of extent radial to the longitudinal axis direction. This achieves, for example, the technical advantage that, on the one hand, the first sealing means and the second sealing means are optimally supported and therefore an optimum sealing effect can be achieved. The region of the spacer means that protrudes beyond the first sealing means or second sealing means in a direction of extension which is radial relative to the longitudinal axis direction corresponds here to the stopper. The stopper is designed, in particular, to stop against the first valve seat and the second valve seat. In other words, the stopper forms a defined stop between the valve body and the first or second sealing seat. In this case, on the other hand, at the same time the technical advantage is achieved that the force acting on the first sealing means or the second sealing means can be safely and reliably limited to the sealing force necessary for reliable sealing of the corresponding first or second flow path.

In this case, the shape and dimensions of the stopper and/or of the first and second sealing seats are configured to be designed to cooperate in such a way that the tightness requirements on the sealing means are met when it bears against the first or second sealing seat, and at the same time a protective function can be provided for the sealing means, for example against being pressed off, crushed (squeezed) or plastic deformation. In this way, the adaptability of the sealing means can be additionally improved and the resistance of the sealing means to high forces, which act on the valve body, for example, owing to high pressure differences, can be improved. Overall, the service life of the sealing means can therefore be extended.

Advantageously, in this case, the spacer means and the stopper can be designed in one piece. In other words, the stopper corresponds to a section of the spacer means. It is therefore particularly simple and accurate to manufacture. In this case, in a sectional view along the longitudinal axis direction, the stopper can comprise at least substantially the same thickness in the direction of extension which is radial relative to the longitudinal axis direction as the section of the spacer means received between the first sealing means and the second sealing means. In other words, the spacer means can comprise an at least substantially rectangular cross-sectional shape.

According to an advantageous development, the stopper comprises a first stroke limitation means extending in the direction of the first sealing seat and a second stroke limitation means extending in the direction of the second sealing seat. In other words, the protruding section of the spacer element forming the stopper comprises a first stroke limitation means extending in the direction of the first sealing seat and a second stroke limitation means extending in the direction of the second sealing seat, so that in a sectional view of the spacer means along the longitudinal axis direction in the direction of extension which is radial relative to the longitudinal axis direction, a thickness of the stopper is greater than the thickness of the section of the spacer means received between the first and second sealing means. In other words, the thickness of the stopper is greater by the first stroke limitation means and the second stroke limitation means than the thickness of the section of the spacer means lying between the first and second sealing means. The stroke of the valve body can thereby be easily limited and the force which acts on the first or second sealing means in a respective contact position can advantageously be limited. This protects against overloading and defects of the first and/or second sealing means and increases their service life. The spacer means can therefore present an at least essentially T-shaped cross-section along the longitudinal axis direction.

According to a further advantageous embodiment of the proportional valve arrangement, a contact surface of the portion of the first sealing means with the first sealing seat and a contact surface of the portion of the second sealing means with the second sealing seat are designed to be inclined with respect to the longitudinal axis direction. This achieves, for example, the additional technical advantage that the valve body can move into the first sealing seat in a self-centering manner at the contact surface of the first section owing to the inclination geometry with respect to the longitudinal axis direction. As a result, an optimum sealing effect can be achieved on the one hand and, on the other hand, higher manufacturing tolerances of the entire proportional valve arrangement can be realized as a result of the self-centering of the inclined contact surface of the first sealing means, which overall lowers the production costs. The same applies analogously to the contact surface of the first section of the second sealing means, wherein, as a result of its inclination with respect to the longitudinal axis direction, when the second sealing means moves into the second sealing seat, a self-centering effect can be achieved in addition to the already implemented optimum sealing effect. This allows, analogously to the first section of the first sealing means, reduced production costs as a result of relatively large manufacturing tolerances.

According to a further embodiment, an inclination angle of the contact surface of the first portion of the first sealing means with respect to the longitudinal axis direction lies in a range greater than 10° and less than 45° and an inclination angle of the contact surface of the first portion of the second sealing means with respect to the longitudinal axis direction lies in a range greater than 10° and less than 45°. This achieves, for example, the technical advantage that, on the one hand, the inclined contact surface allows a self-centering effect when it enters the first sealing seat or the second sealing seat. In addition, as a result of the range greater than 10% and less than 45% of the inclination angle, an optimum sealing effect exists both at the contact surface of the first portion of the first sealing means and at the contact surface of the second portion of the second sealing means with respect to the first sealing seat and the second sealing seat. For example, the contact surface of the sealing means can deform as a function of the force with which the sealing means is pressed against the sealing seat, as a result of which the inclination angle can change. For example, an inclination angle of 45° can exist before the contact surface comes into contact with the sealing seat and, as a result of an increased force with which the valve piston presses against the sealing seat, can lead to elastic deformation of the relevant sealing means, as a result of which an inclination angle of the relevant contact surface also changes with respect to the longitudinal axis direction. This change can be explained by elastic deformation of the relevant sealing means, wherein the elastic deformation of the sealing means ensures an improved sealing effect.

According to a further advantageous embodiment of the proportional valve arrangement, the first sealing seat and the second sealing seat each comprise a first seat portion for receiving the contact surface of the first sealing means and the contact surface of the second sealing means and a second seat portion for receiving the stopper of the spacer means. In other words, the first seat portion of the first sealing seat serves to receive the contact surface of the first sealing means and therefore to form and achieve the sealing function, while the second seat portion of the first sealing seat serves to form a stop for the spacer means, and in particular for the stopper of the spacer means, and therefore to provide stroke limitation for the valve body. The portions serving to achieve the sealing effect and the portions serving to limit the stroke are therefore advantageously spatially and functionally separated from one another on the first sealing seat, as a result of which the respective functions can be particularly reliably met. It can particularly advantageously be ensured in this way that the respective functions of the first seat portion and of the second seat portion of the first sealing seat therefore do not influence one another or impair the performance of their function. Production can therefore also be simplified since the necessary tolerances and production requirements can be adapted to the function of the respective seat portion. The same applies analogously to the second sealing seat.

According to a further advantageous development, the first seat portion of the first sealing seat and the first seat portion of the second sealing seat each form a convex contour on the first or second sealing seat. In other words, the portion of the respective sealing seat which is designed for abutment against the first or second sealing means presents a continuous shape which ensures that the first or second sealing means remains intact after (repeated) exertion of the sealing force. More precisely, the first seat portion of the first or second sealing seat does not comprise any sharp, pointy and/or otherwise shaped edges pointing outwards in the direction of the first or second sealing means which would endanger the integrity of the first or second sealing means. The service life of the respective sealing means and therefore of the entire valve arrangement is thereby advantageously improved.

According to a further advantageous embodiment of the proportional valve arrangement, the spacer means each comprises a sealing means reservoir on a surface facing the first sealing seat and on a surface facing the second sealing seat in a direction radial to the longitudinal axis direction, in particular within the stopper, on a position corresponding to the first or second sealing seat. In other words, the spacer means comprises, in a cross-sectional view in the longitudinal axis direction, two mutually opposite concave portions which form the sealing means reservoirs. The sealing means reservoirs are arranged at the level of the first sealing seat and of the second sealing seat on a position viewed in a direction of extension which is radial relative to the longitudinal axis direction.

According to the present application, a sealing means reservoir is understood to mean an at least essentially three-dimensional, inwardly extending structure which is shaped such that it can accommodate additional sealing means material. In other words, the sealing means reservoir corresponds to a recess on the spacer means which reduces the thickness of the spacer means. The position of the sealing means reservoir in the direction of extension which is radial relative to the longitudinal axis direction corresponds to a position which corresponds to the first sealing seat on the first side and to the second sealing seat on the second side which is opposite the first side. Thus, the thickness of the first sealing means or the thickness of the second sealing means can be increased on that section of the first sealing means which makes contact with the first sealing seat or on that section of the second sealing means which makes contact with the second sealing seat. This affords better protection of the first or second sealing means against defects or plastic deformation. The sealing effect can therefore be ensured more reliably and the first and second sealing means can be protected against failure.

According to an advantageous development, the sealing means reservoir is formed in a constriction of the spacer means. Alternatively, the sealing means reservoir can be formed in a circumferential groove of the spacer means, in particular with a partially annular base surface, or in a circumferential undercut.

According to an advantageous development, the spacer means can be formed so as to widen in the direction of extension which is radial relative to the longitudinal axis direction from the sealing means reservoir towards an end of the spacer means which is opposite the stopper (i.e. in the direction of the valve body). In other words, in a cross-sectional view, a section of the spacer element received between the first sealing means and the second sealing means is formed at least essentially in the shape of a dovetail. For example, the spacer means can widen at least essentially in the manner of a drop from the sealing means reservoir in the direction of the end of the spacer means which is opposite the stopper. The connection between the first sealing means, the second sealing means and the spacer means can thus be improved. This shaping at the same time allows improved adhesion of the first or second sealing means to the spacer means and better stabilization of the first and second sealing means.

According to an advantageous development of such a spacer means, the thickness of the stopper in the longitudinal axis direction corresponds to a maximum value of the thickness of the widening section of the spacer means.

According to an advantageous embodiment, the proportional valve arrangement comprises a pressure bypass which connects the first outflow opening to the valve body chamber when the valve body bears against the second sealing seat. This achieves, for example, the technical advantage that pressure compensation through the valve body is possible in a symmetrical manner and without an external bypass. This allows a compact design and allows particularly simple and cost-effective production of a force-compensated proportional valve arrangement. The effective pressure-loaded surfaces on the valve body are designed such that the surfaces which press the valve body to the right are of the same size as the surfaces which press the latter to the left. Via the bypass, the same pressure (pressure-compensated) results to the left and to the right on the surfaces and therefore an equilibrium of forces results on the valve body. This design, in conjunction with a stepper motor and therefore a restoring element which is not present, results in a completely force-compensated system, and therefore the self-locking means does not have to hold any forces or only very small forces.

According to an embodiment based thereon, the pressure bypass comprises a connecting line through the valve body. For example, the connecting line extends along the geometric longitudinal axis of the valve body. This achieves, for example, the technical advantage that the refrigerant can flow directly through the valve body. This results in simple and symmetrical pressure compensation of the refrigerant, which overall allows the force-compensated configuration of the valve body.

The above-described, different and exemplary features can be combined with one another according to the invention, insofar as this is technically expedient and suitable. Further advantageous embodiments and combinations of features of the invention result from the following detailed description and the entirety of the patent claims.

### BRIEF DESCRIPTION OF THE DRAWINGS

The drawings used to explain the exemplary embodiment show:

FIG. 1 a cross-sectional view of a proportional valve arrangement according to a first embodiment of the invention,

FIG. 2 an enlarged detailed view of a valve body according to FIG. 1,

FIG. 3 a cross-sectional view of a further embodiment of a proportional valve arrangement according to the invention, and

FIG. 4 an enlarged detailed view of a valve body according to FIG. 3,

FIG. 5 an enlarged detailed view of a valve body according to a further embodiment of a proportional valve arrangement according to the invention,

FIG. 6 an enlarged detailed view of a valve body according to a further embodiment of a proportional valve arrangement according to the invention,

FIG. 7 an enlarged detailed view of a sealing element of a valve body according to a further embodiment of a proportional valve arrangement according to the invention, and

FIG. 8 an enlarged detailed view of a valve body according to a further embodiment of a proportional valve arrangement according to the invention.

In principle, identical parts are provided with identical reference numerals in the figures.

### DETAILED DESCRIPTION

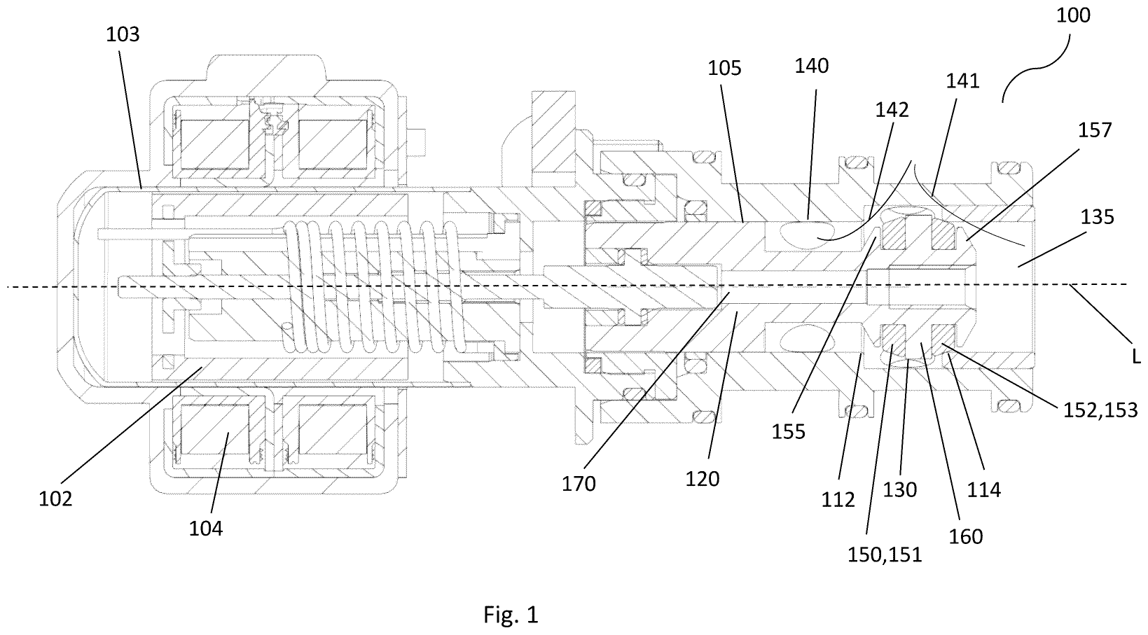

FIG. 1 shows a cross-sectional view of a proportional valve arrangement 100 according to a first embodiment of the invention. The proportional valve arrangement 100 comprises a rotor 102 which is arranged within a containment shroud 103. The rotor 102 is located in a valve body chamber 105 and is directly connected to a valve body 120. A stator 104 which is designed to set the rotor 102 in rotation is arranged radially outside the containment shroud 103. The valve body chamber 105 comprises an inflow opening 130, a first outflow opening 135 and a second outflow opening 140. The first outflow opening 135 and the second outflow opening 140 is configured to be opened as a function of the position of the valve body 120 which is designed to be transferable in the valve body chamber 105 in a longitudinal axis direction L between a first sealing seat 112 and a second sealing seat 114.

The valve body 120 is configured to be moved variably between the first sealing seat 112 and the second sealing seat 114, as a result of which both the first flow path 141 and the second flow path 142 are opened at the same time. The more the valve body 120 moves in the direction of the first sealing seat 112, the smaller the flow cross section of the second flow path 142 and the larger the flow cross section of the first flow path 141. The more the valve body 120 moves in the direction of the second sealing seat 114, the smaller the flow cross section of the first flow path 141 and the larger the flow cross section of the second flow path 142.

The valve body 120 completely opens the first flow path 141 from the inflow opening 130 to the first outflow opening 135 when the valve body 120 bears against the first sealing seat 112. The second flow path 142 is completely closed in this case. The valve body 120 opens the second flow path 142 from the inflow opening 130 to the second outflow opening 140 when the valve body 120 bears against the second sealing seat 114. In this case, the first flow path 141 is completely closed. The proportional valve arrangement 100 is continuously movable between the abutment against the first sealing seat 112 and the second sealing seat 114. The valve body 120 comprises a first sealing means 150 which is designed to bear against the first sealing seat 112. In addition, the valve body 120 comprises a second sealing means 152 which is designed to bear against the second sealing seat 114. Preferably, the first sealing means 150 and the second sealing means 152 are each produced from a plastic. The first sealing means 150 comprises a first section 151 which is designed to bear against the first sealing seat 112. Analogously, the second sealing means 152 comprises a first section 153 which is designed to bear against the second sealing seat 114. Both the first sealing means 150 and the second sealing means 152 are each arranged tensioned in the longitudinal axis direction L between a first holding means 155 and a second holding means 157. Centrally along the longitudinal axis direction L, the proportional valve arrangement 100 comprises a pressure bypass 170 which connects the first outflow opening 135 to the valve body chamber 105 when the valve body 120 bears against the second sealing seat 114. The pressure bypass 170 is designed in the form of a connecting line through the valve body 120.

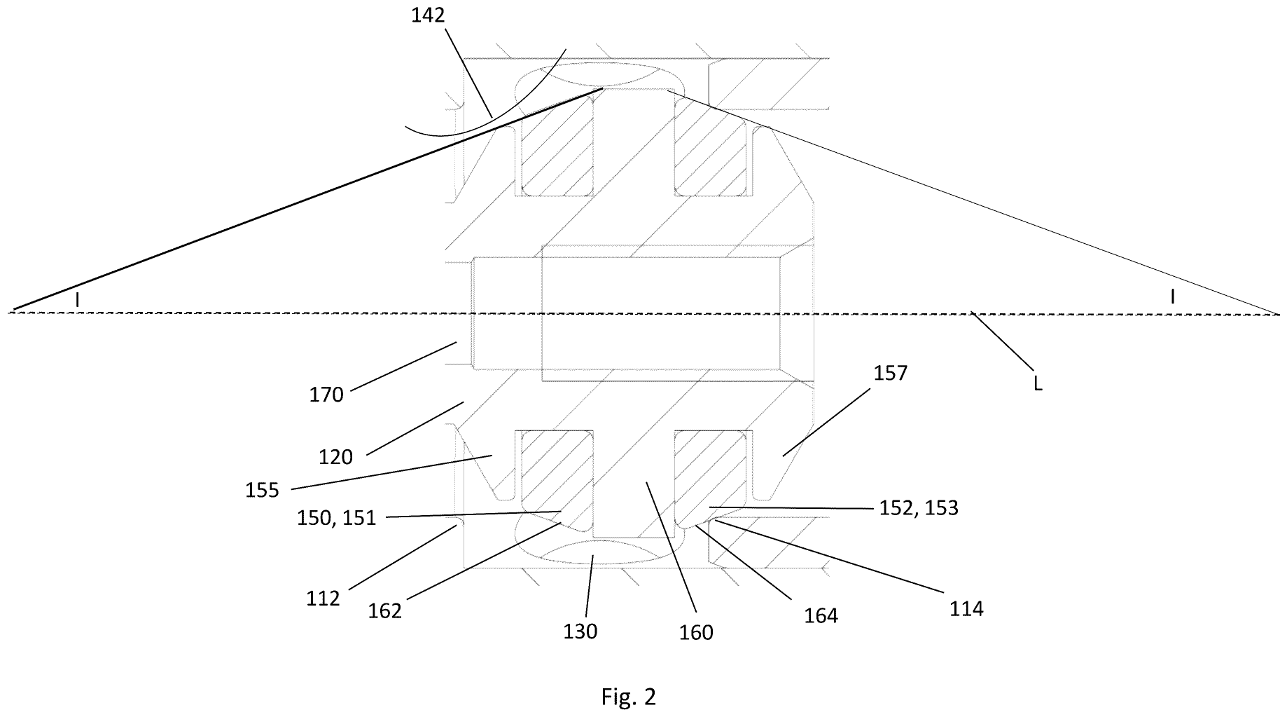

FIG. 2 shows an enlarged detailed view of a valve body 120 according to FIG. 1. The valve body 120 can be seen within the valve body chamber 105 with the inflow opening 130, the first outflow opening 135 and a second outflow opening 140. The valve body 120 bears against the second sealing seat 114, as a result of which the second flow path 142 from the inflow opening 130 to the second outflow opening 140 is opened. A contact surface 162, arranged radially on the outside, of the first sealing means 150 serves to come into direct contact with the first sealing seat 112. An inclination angle I of the contact surface 162 with respect to the longitudinal axis direction L is approximately 30°. Analogously thereto, a contact surface 164, arranged radially on the outside, of the second sealing means 152 serves to come into direct contact with the second sealing seat 114. An inclination angle I of the contact surface 164 with respect to the longitudinal axis direction L is approximately 30°.

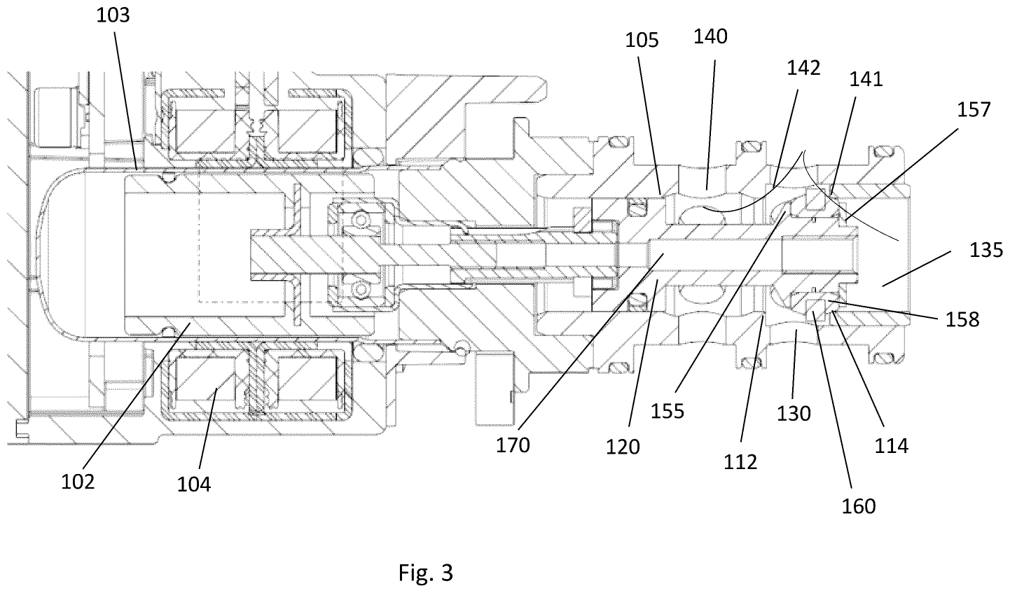

FIG. 3 shows a cross-sectional view of a further embodiment of a proportional valve arrangement 100 according to the invention. The proportional valve arrangement 100 comprises the rotor 102 which is arranged within the containment shroud 103. The rotor 102 is located in the valve body chamber 105 and is directly connected to the valve body 120. The stator 104 which is designed to set the rotor 102 in rotation is arranged radially outside the containment shroud 103. The valve body chamber 105 comprises the inflow opening 130, the first outflow opening 135 and the second outflow opening 140. The first outflow opening 135 and the second outflow opening 140 is configured to be opened as a function of the position of the valve body 120 which is designed to be transferable in the valve body chamber 105 in a longitudinal axis direction L between the first sealing seat 112 and the second sealing seat 114. The valve body 120 opens the first flow path 141 from the inflow opening 130 to the first outflow opening 135 when the valve body 120 bears against the first sealing seat 112. The valve body 120 opens the second flow path 142 from the inflow opening 130 to the second outflow opening 140 when the valve body 120 bears against the second sealing seat 114. The proportional valve arrangement 100 is continuously movable between the abutment against the first sealing seat 112 and the second sealing seat 114. As a result, the valve body 120 can be moved variably between the first sealing seat 112 and the second sealing seat 114, as a result of which both the first flow path 141 and the second flow path 142 are opened at the same time. The more the valve body 120 moves in the direction of the first sealing seat 112, the smaller the flow cross section of the second flow path 142 and the larger the flow cross section of the first flow path 141. The more the valve body 120 moves in the direction of the second sealing seat 114, the smaller the flow cross section of the first flow path 141 and the larger the flow cross section of the second flow path 142.

The valve body 120 comprises an integral sealing means 158 which is designed to bear against the first sealing seat 112. At the same time, the integral sealing means 158 is designed to bear against the second sealing seat 114.

Preferably, the integral sealing means 158 is produced from a plastic. In a longitudinal sectional view, the integral sealing means 158 is U-shaped. A spacer means 160 is arranged between the two legs of the U-shaped integral sealing element 158. The spacer means 160 protrudes beyond the two legs in a direction of extension which is radial relative to the longitudinal axis direction L. Both the first leg and the second leg of the integral sealing means 158 are each arranged tensioned in the longitudinal axis direction L between a first holding means 155 and a second holding means 157. The second holding means 157 is designed to be displaceable in the longitudinal axis direction L.

Centrally along the longitudinal axis direction L, the proportional valve arrangement 100 comprises the pressure bypass 170 which connects the first outflow opening 135 to the valve body chamber 105 when the valve body 120 bears against the second sealing seat 114. The pressure bypass 170 is designed in the form of a connecting line through the valve body 120.

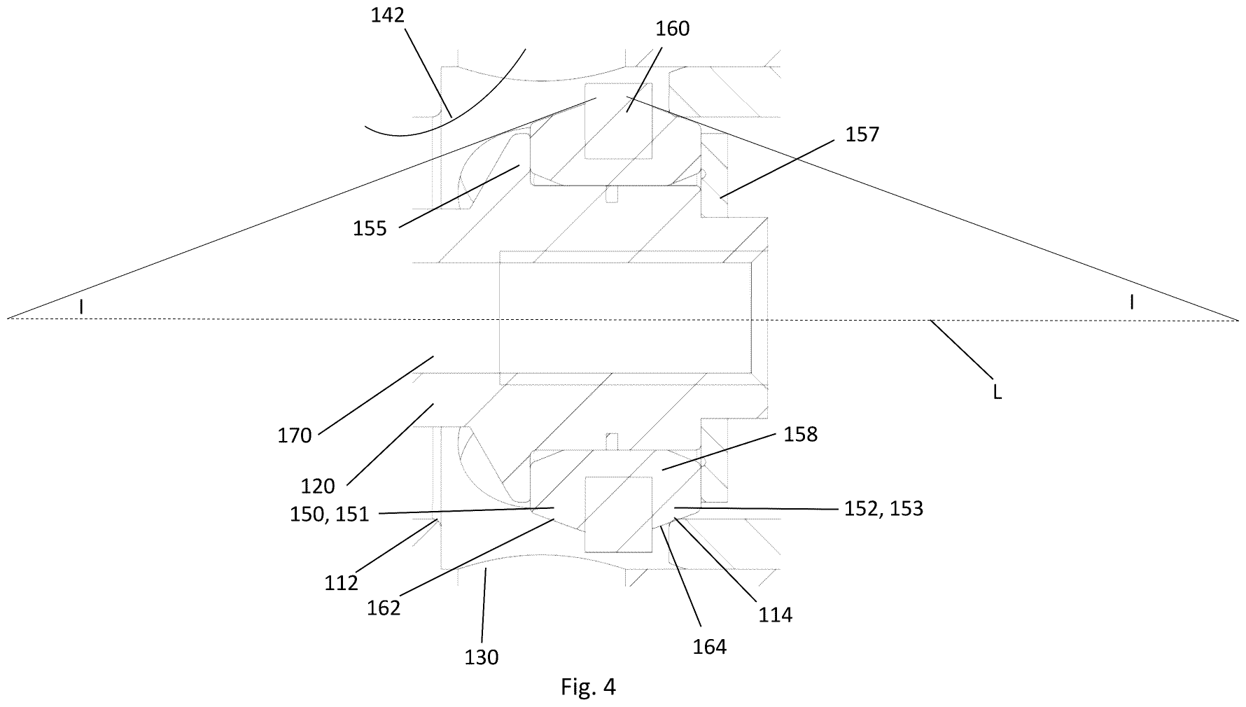

FIG. 4 shows an enlarged detailed view of a valve body 120 according to FIG. 3. The valve body 120 can be seen within the valve body chamber 105 with the inflow opening 130, the first outflow opening 135 and a second outflow opening 140. The valve body 120 bears against the second sealing seat 114, as a result of which the second flow path 142 from the inflow opening 130 to the second outflow opening 140 is opened. A contact surface 162, arranged radially on the outside, of the first leg of the integral sealing means 158 serves to come into direct contact with the first sealing seat 112. An inclination angle I of the contact surface 162 with respect to the longitudinal axis direction L is approximately 30°. Analogously thereto, a contact surface 164, arranged radially on the outside, of the second leg of the integral sealing means 158 serves to come into direct contact with the second sealing seat 114. An inclination angle I of the contact surface 164 with respect to the longitudinal axis direction L is approximately 30°.

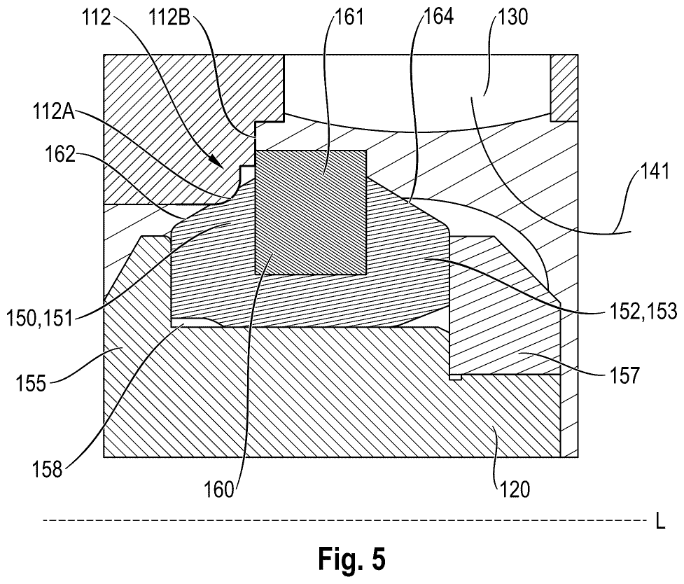

FIG. 5 shows an enlarged detailed view of a valve body 120 of a further embodiment of a proportional valve arrangement 100 according to the invention. The proportional valve arrangement 100 is comparable with the above-described proportional valve arrangement 100 according to FIGS. 3 and 4 and comprises at least essentially the same features. Therefore, in particular, the differences will be discussed below.

In particular, the proportional valve arrangement 100 comprises the rotor 102 which is arranged within the containment shroud 103. The rotor 102 is located in the valve body chamber 105 and is directly connected to the valve body 120. The stator 104 which is designed to set the rotor 102 in rotation is arranged radially outside the containment shroud 103. The valve body chamber 105 comprises the inflow opening 130, the first outflow opening 135 and the second outflow opening 140. The first outflow opening 135 and the second outflow opening 140 are configured to be opened as a function of the position of the valve body 120 which is designed to be transferable in the valve body chamber 105 in a longitudinal axis direction L between the first sealing seat 112 and the second sealing seat 114. The valve body 120 opens the first flow path 141 from the inflow opening 130 to the first outflow opening 135 when the valve body 120 bears against the first sealing seat 112. The valve body 120 opens the second flow path 142 from the inflow opening 130 to the second outflow opening 140 when the valve body 120 bears against the second sealing seat 114. The proportional valve arrangement 100 is continuously movable between the abutment against the first sealing seat 112 and the second sealing seat 114. As a result, the valve body 120 can be moved variably between the first sealing seat 112 and the second sealing seat 114, as a result of which both the first flow path 141 and the second flow path 142 are opened at the same time. The more the valve body 120 moves in the direction of the first sealing seat 112, the smaller the flow cross section of the second flow path 142 and the larger the flow cross section of the first flow path 141. The more the valve body 120 moves in the direction of the second sealing seat 114, the smaller the flow cross section of the first flow path 141 and the larger the flow cross section of the second flow path 142.

Centrally along the longitudinal axis direction L, the proportional valve arrangement 100 comprises the pressure bypass 170 which connects the first outflow opening 135 to the valve body chamber 105 when the valve body 120 bears against the second sealing seat 114. The pressure bypass 170 is designed in the form of a connecting line through the valve body 120.

According to the illustration in FIG. 5, the valve body 120 comprises an integral sealing means 158 which is designed to bear against the first sealing seat 112. At the same time, the integral sealing means 158 is designed to bear against the second sealing seat 114.

Preferably, the integral sealing means 158 is produced from a plastic, for example an elastomer. In a longitudinal sectional view, the integral sealing means 158 is U-shaped. A spacer means 160 is arranged between the two legs, formed by the first sealing means 150 and the second sealing means 152, of the U-shaped integral sealing element 158. The spacer means 160 protrudes beyond the two legs in a direction of extension which is radial relative to the longitudinal axis direction L.

Both the first leg and the second leg of the integral sealing means 158 are each arranged tensioned in the longitudinal axis direction L between a first holding means 155 and a second holding means 157. The second holding means 157 is designed to be displaceable in the longitudinal axis direction L.

A contact surface 162, arranged radially on the outside, of the first leg of the integral sealing means 158 serves to come into direct contact with the first sealing seat 112. An inclination angle I of the contact surface 162 with respect to the longitudinal axis direction L is approximately 30°. Analogously thereto, a contact surface 164, arranged radially on the outside, of the second leg of the integral sealing means 158 serves to come into direct contact with the second sealing seat 114. An inclination angle I of the contact surface 164 with respect to the longitudinal axis direction L is approximately 30°.

In the enlarged cross-sectional view according to FIG. 5, in particular a valve position is shown in which the first sealing means 150 bears with a first section 151 against the first sealing seat 112, and only opens the first flow path 141. In other words, the second flow path 142 is blocked. Unlike in the above-described embodiments, the first sealing seat 112 comprises an adapted outer contour which is designed at the same time to form the sealing contact and to form a stop for the spacer means 161.

The first sealing seat 112 comprises a first seat portion 112A for receiving a contact surface 162 of the first sealing means 150 and a second seat portion 112B for receiving the spacer means 160. In other words, the spacer means 160 limits a stroke of the valve body 120 in the direction of the first sealing seat 112 and is designed to stop against the second seat portion 112B of the first sealing seat 112. The first seat portion 112A in this case comprises a continuously designed, in particular convex, shaping in the direction of the first sealing element 150. The second seat portion 112B of the first sealing seat 112 is formed, for example, as a step formed in the longitudinal axis direction L.

During the transfer of the valve body 120 into the first sealing seat 112, the first sealing means 150 firstly comes into contact with the first seat portion 112A of the first sealing seat 112 with its contact surface 162 and is elastically deformed until the spacer means 160 makes contact with the second seat portion 112B of the first sealing seat 112 and prevents further movement of the valve body 120.

The spacer means 160 comprises a stopper 161. The stopper 161 corresponds at least substantially to a section of the spacer means 160 which protrudes beyond the first sealing means 150 and the second sealing means 152 in the direction of extension which is radial relative to the longitudinal axis direction L. In other words, the stopper 161 and the spacer means 160 are designed in one piece. The stopper 161 is designed to stop against the second seat portion 112B of the first sealing seat 112 and to stop against a second seat portion 114B of the second sealing seat 114.

As shown in FIG. 5, the stopper 161 can comprise the same thickness as the spacer means 160 in a cross-sectional view in the longitudinal axis direction L. In other words, the spacer means 160 comprises an at least essentially rectangular cross-section. Alternatively, it is entirely conceivable that the stopper 161 can comprise a larger thickness than the spacer means 160 in a cross-sectional view in the longitudinal axis direction L. In other words, the spacer means 160 can comprise an at least essentially T-shaped cross-section.

Even if this is not explicitly shown in FIG. 5, the second sealing seat 114 analogously comprises a first seat portion 114A for receiving a contact surface 164 of the second sealing means 152 and the second seat portion 114B for receiving the spacer means 160. The features described above with respect to the first sealing seat 112 and the first sealing means 150 also apply correspondingly to the second sealing seat 114 and the second sealing means 152.

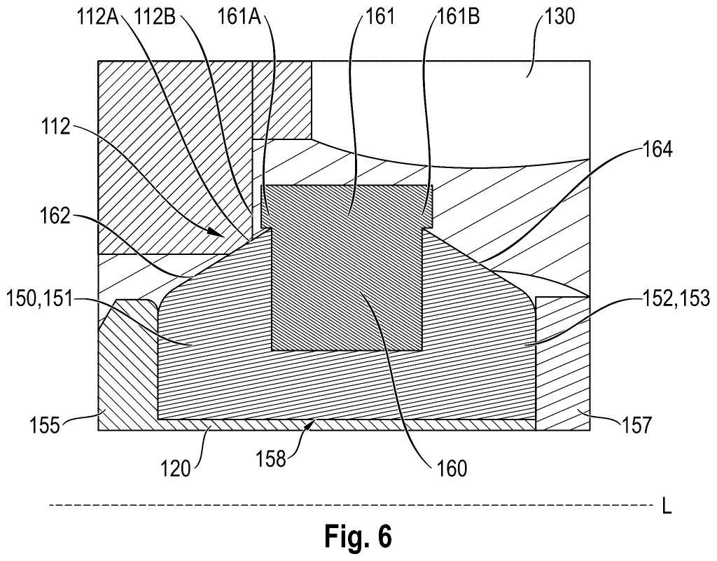

FIG. 6 shows an enlarged detailed view of a valve body 120 of a further embodiment of a proportional valve arrangement 100 according to the invention. The proportional valve arrangement 100 is comparable with the above-described proportional valve arrangements 100, in particular with that according to FIG. 5, and comprises essentially the same features. Therefore, the differences will be discussed below. The remaining features correspond to the above features and a repeated description thereof will be dispensed with.

According to the illustration in FIG. 6, the valve body 120 comprises an integral sealing means 158 which is designed to bear against the first sealing seat 112. At the same time, the integral sealing means 158 is designed to bear against the second sealing seat 114.

Preferably, the integral sealing means 158 is produced from a plastic, for example an elastomer. In a longitudinal sectional view, the integral sealing means 158 is U-shaped. A spacer means 160 is arranged between the two legs, formed by the first sealing means 150 and the second sealing means 152, of the U-shaped integral sealing element 158. The spacer means 160 protrudes beyond the two legs in a direction of extension which is radial relative to the longitudinal axis direction L.

Both the first leg and the second leg of the integral sealing means 158 are each arranged tensioned in the longitudinal axis direction L between a first holding means 155 and a second holding means 157. The second holding means 157 is designed to be displaceable in the longitudinal axis direction L.

In the enlarged cross-sectional view according to FIG. 6, in particular a valve position is shown in which the first sealing means 150 is arranged with a first section 151 shortly before abutment against the first sealing seat 112, and opens the first flow path 141 and still partially the second flow path 142.

In the valve body 120 shown in FIG. 6, the spacer means 160 comprises a stopper 161. The stopper 161 corresponds at least substantially to a section of the spacer means 160 which protrudes beyond the first sealing means 150 and the second sealing means 152 in the direction of extension which is radial relative to the longitudinal axis direction L. In other words, the stopper 161 and the spacer means 160 are designed in one piece.

In contrast to the embodiment shown in FIG. 5, the stopper 161 in the embodiment shown in FIG. 6 comprises a first stroke limiting means 161A in a cross-sectional view in the longitudinal axis direction L in the direction of the first sealing seat 112 and a second stroke limiting means 161B in the direction of the second sealing seat 114. In other words, the stopper 161 can comprise a larger thickness than the spacer means 160 in a cross-sectional view in the longitudinal axis direction L. In particular, in a cross-sectional view in the longitudinal axis direction L, the stopper 161 is greater by the additional extension of the first stroke limitation means 161A and the second stroke limitation means 161B than the thickness of the section of the spacer means 160 received between the first sealing means 150 and the second sealing means 152. In other words, the spacer means 160 can comprise an at least essentially T-shaped cross-section.

Here, too, the first sealing seat 112 can comprise a first seat portion 112A for receiving a contact surface 162 of the first sealing means 150 and a second seat portion 112B for receiving the first stroke limitation means 161A of the spacer means 160. In other words, the first stroke limitation means 161A of the spacer means 160 limits a stroke of the valve body 120 in the direction of the first sealing seat 112 and is designed to stop against the second seat portion 112B of the first sealing seat 112. As shown in FIG. 6, the first seat portion 112A in this case comprises an inclined shaping which corresponds essentially to the inclination of the first contact surface 162 of the first section 151 of the first sealing means 150. The second seat portion 112B of the first sealing seat 112 in this case corresponds to a wall which extends in a direction of extension which is radial relative to the longitudinal axis direction L in the direction of the inflow opening 130.

During the transfer of the valve body 120 into the first sealing seat 112, the first sealing means 150 firstly comes into contact with the first seat portion 112A of the first sealing seat 112 with its contact surface 162 and is elastically deformed to form the sealing contact until the first stroke limitation means 161A of the stopper 161 makes contact with the second seat portion 112B of the first sealing seat 112 and prevents further movement of the valve body 120.

Even if this is not explicitly shown in FIG. 6, the second sealing seat 114 analogously comprises a first seat portion 114A for receiving a contact surface 164 of the second sealing means 152 and a second seat portion 114B for receiving the second stroke limitation means 161B of the stopper 161. The features described above with respect to the first sealing seat 112 and the first sealing means 150 also apply correspondingly to the second sealing seat 114 and the second sealing means 152.

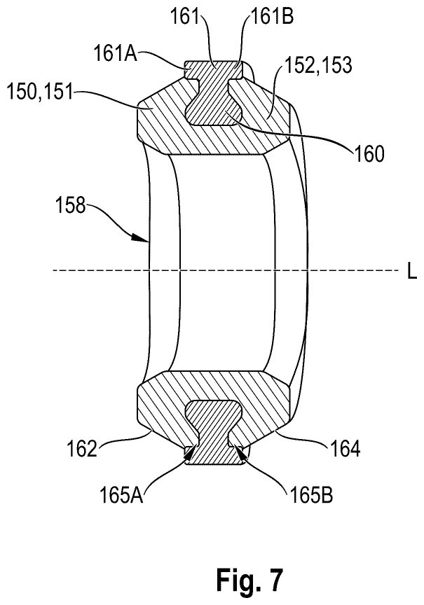

FIG. 7 shows an enlarged detailed view of a one-piece integral sealing element 158 of a valve body 120 of a further embodiment of a proportional valve arrangement 100 according to the invention. The proportional valve arrangement 100 is comparable with the above-described proportional valve arrangements 100, in particular that according to FIG. 6, and comprises essentially the same features. Therefore, the differences will be discussed below. The remaining features correspond to the above features and a repeated description thereof will be dispensed with.

According to the illustration in FIG. 7, the valve body 120 comprises an integral sealing means 158 which is designed to bear against the first sealing seat 112. At the same time, the integral sealing means 158 is designed to bear against the second sealing seat 114.

Preferably, the integral sealing means 158 is produced from a plastic, for example an elastomer. In a longitudinal sectional view, the integral sealing means 158 is at least essentially U-shaped. A spacer means 160 is arranged between the two legs, formed by the first sealing means 150 and the second sealing means 152, of the U-shaped integral sealing element 158. The spacer means 160 protrudes beyond the two legs in a direction of extension which is radial relative to the longitudinal axis direction L.

Both the first leg and the second leg of the integral sealing means 158 are each configured to be arranged tensioned in the longitudinal axis direction L between a first holding means 155 and a second holding means 157. The second holding means 157 is designed to be displaceable in the longitudinal axis direction L.

In the enlarged cross-sectional view according to FIG. 7 of the one-piece integral sealing element 158, the spacer means 160 comprises a stopper 161. The stopper 161 corresponds at least substantially to a section of the spacer means 160 which protrudes beyond the first sealing means 150 and the second sealing means 152 in the direction of extension which is radial relative to the longitudinal axis direction L. In other words, the stopper 161 and the spacer means 160 are designed in one piece.

As further shown in FIG. 7, the stopper 161 comprises a first stroke limitation means 161A in a cross-sectional view in the longitudinal axis direction L in the direction of the first sealing seat 112 and a second stroke limitation means 161B in the direction of the second sealing seat 114.

Here, too, the first sealing seat 112 can comprise a first seat portion 112A for receiving a contact surface 162 of the first sealing means 150 and a second seat portion 112B for receiving the first stroke limitation means 161A of the spacer means 160. In other words, the first stroke limitation means 161A of the spacer means 160 limits a stroke of the valve body 120 in the direction of the first sealing seat 112 and is designed to stop against the second seat portion 112B of the first sealing seat 112. In this case, the first seat portion 112A can comprise an inclined shaping which corresponds essentially to the inclination of the first contact surface 162 of the first section 151 of the first sealing means 150. Alternatively, it is also conceivable that the first seat portion 112A comprises a convex contour curved in the direction of the first sealing element 150. The second seat portion 112B of the first sealing seat 112 in this case can correspond to a wall which extends in a direction of extension which is radial relative to the longitudinal axis direction L in the direction of the inflow opening 130 or can be formed as an additional step.

During the transfer of the valve body 120 into the first sealing seat 112, the first sealing means 150 firstly comes into contact with the first seat portion 112A of the first sealing seat 112 with its contact surface 162 and is elastically deformed until the first stroke limitation means 161A of the stopper 161 makes contact with the second seat portion 112B of the first sealing seat 112 and prevents further movement of the valve body 120.

Even if this is not explicitly shown in FIG. 7, the second sealing seat 114 analogously comprises a first seat portion 114A for receiving a contact surface 164 of the second sealing means 152 and a second seat portion 114B for receiving the second stroke limitation means 161B of the stopper 161. The features described above with respect to the first sealing seat 112 and the first sealing means 150 also apply correspondingly to the second sealing seat 114 and the second sealing means 152.

The embodiment shown in FIG. 7 differs from the embodiment shown in FIG. 6 in the structure of the spacer means 160. In particular, the section of the spacer means 160 received between the first sealing means 150 and the second sealing means 152 comprises a different shaping.

According to the embodiment shown in FIG. 7, the spacer element 160 comprises two sealing means reservoirs 165A, 165B within the stopper 161 in the direction of extension which is radial relative to the longitudinal axis direction L. The two sealing means reservoirs 165A, 165B are arranged opposite one another in the longitudinal axis direction L. A first sealing means reservoir 165A is arranged on a side of the spacer means 160 facing the first sealing seat 112. A second sealing means reservoir 165B is arranged on a side of the spacer means 160 facing the second sealing seat 114. The first and second sealing means reservoirs 165A, 165B are preferably formed directly adjacent to the stopper 161.

In the direction of extension which is radial relative to the longitudinal axis direction L, the two sealing means reservoirs 165A, 165B are arranged on a position on which the first sealing seat 112 and the second sealing seat 114, in particular the first seat portion 112A of the first sealing seat 112 and the first seat portion 114B of the second sealing seat 114, are located. In other words, a parallel to the longitudinal axis direction L which runs through the first seat portion 112A of the first sealing seat 112 at the point at which, when the valve body 120 bears against the first sealing seat 112, the first seat portion 112A is in sealing contact with the contact surface 162 of the first section 151 of the first sealing means 150 also runs through the first and second sealing means reservoirs 165A, 165B of the spacer means 160.

The first sealing means reservoir 165A is an at least essentially three-dimensional structure which extends inwardly in the longitudinal axis direction L into the section of the spacer means 160 received between the first sealing means 150 and the second sealing means 152 and which is designed such that, in the region of the spacer means 160 which, when the first sealing means 150 bears against the first sealing seat 112, corresponds to the position of the first seat portion 112A of the first sealing seat 112, the first sealing means 150 is equipped with additional sealing means material. Likewise, the second sealing means reservoir 165B is an at least essentially three-dimensional structure which extends inwardly in the longitudinal axis direction L into the section of the spacer means 160 received between the first sealing means 150 and the second sealing means 152 and which is designed such that, in the region of the spacer means 160 which, when the second sealing means 152 bears against the second sealing seat 114, corresponds to the position of the first seat portion 114A of the second sealing seat 114, the second sealing means 152 is equipped with additional sealing means material.

The first sealing means reservoir 165A and the second sealing means reservoir 165B can each correspond to a recess on the spacer means 160 which reduces the thickness of the spacer means 160. The position of the sealing means reservoir 165A and of the second sealing means reservoir 165B in the direction of extension which is radial relative to the longitudinal axis direction corresponds to a position which corresponds to the first sealing seat 112 on the first side and to the second sealing seat 114 on the second side. Thus, the thickness of the first sealing means 150 or the thickness of the second sealing means 152 can be increased on that section 151 of the first sealing means 150 which makes contact with the first sealing seat 112 or on that section 153 of the second sealing means 152 which makes contact with the second sealing seat 114. As a result, the force necessary for the sealing effect can be distributed better into the first or second sealing means 150, 152, so that the first sealing means 150 and the second sealing means 152 can be protected more reliably against plastic deformation and/or shearing.

For example, both the first sealing means reservoir 165A and the second sealing means reservoir 165B can be formed as circumferential constrictions in the circumferential direction. Alternatively, the first sealing means reservoir 165A and the second sealing means reservoir 165B can be formed as grooves, in particular with a partially annular base surface, or as differently shaped, circumferential undercuts in the circumferential direction.

The section of the spacer means 160 received between the first sealing means 150 and the second sealing means 152 can be formed so as to widen in the direction of extension which is radial relative to the longitudinal axis direction from the first and second sealing means reservoirs 165A, 165B towards an end of the spacer means 160 which is opposite the stopper 161 (i.e. in the direction of the valve body 120). In other words, in a cross-sectional view, the section of the spacer element 160 received between the first sealing means 150 and the second sealing means 152 is formed at least essentially in the shape of a dovetail. For example, the spacer means 160 can widen at least essentially in the manner of a drop from the first and second sealing means reservoirs 165A, 165B in the direction of the end of the spacer means 160 which is opposite the stopper 161.

For example, the thickness of the stopper 161 in the longitudinal axis direction can be exactly the same as a maximum value of the thickness of the widening section of the spacer means 160.

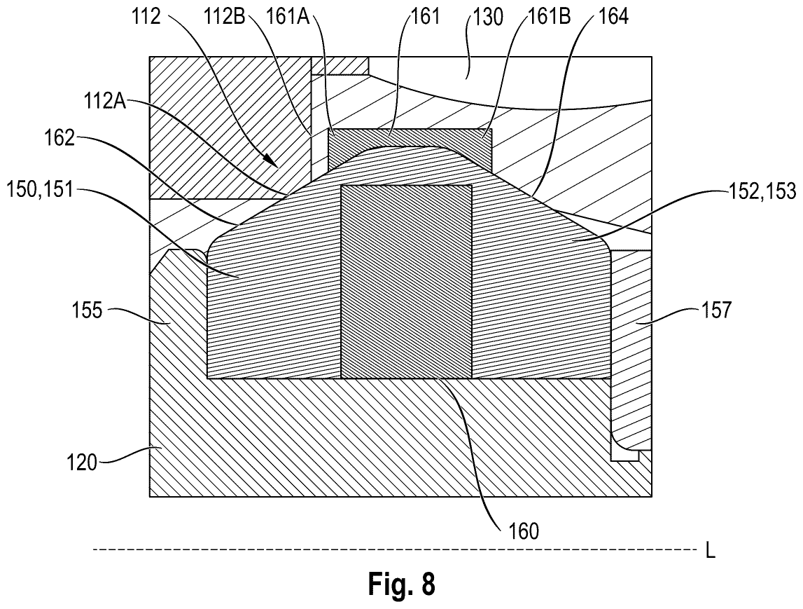

FIG. 8 shows an enlarged detailed view of a valve body 120 of a further embodiment of a proportional valve arrangement 100 according to the invention. The proportional valve arrangement 100 is comparable with the above-described proportional valve arrangements 100, in particular that according to FIG. 6 or 7, and comprises essentially the same features. Therefore, the differences will be discussed below. The remaining features correspond to the above features and a repeated description thereof will be dispensed with.

According to the illustration in FIG. 8, the valve body 120 comprises a first sealing means 150 which is designed to bear against the first sealing seat 112, and a second sealing means 152 which is designed to bear against the second sealing seat 114.

Preferably, the first sealing means 150 and the second sealing means 152 are produced from a plastic, for example an elastomer. A spacer means 160 is arranged between the first sealing means 150 and the second sealing means 152. The spacer means 160 protrudes beyond the first sealing means 150 and the second sealing means 152 in a direction of extension which is radial relative to the longitudinal axis direction L.

The first sealing means 150 and the second sealing means 152 are arranged tensioned in the longitudinal axis direction L between a first holding means 155 and a second holding means 157. The second holding means 157 is designed to be displaceable in the longitudinal axis direction L.

In the enlarged cross-sectional view according to FIG. 8, in particular a valve position is shown in which the first sealing means 150 is arranged with a first section 151 shortly before abutment against the first sealing seat 112, and opens the first flow path 141 and still partially the second flow path 142.

In the valve body 120 shown in FIG. 8, the spacer means 160 comprises a stopper 161. The stopper 161 corresponds at least essentially to a section of the spacer means 160 which protrudes beyond the first sealing means 150 and the second sealing means 152 in the direction of extension which is radial relative to the longitudinal axis direction L. In other words, the stopper 161 and the spacer means 160 are designed in one piece.

As shown in FIG. 8, the stopper 161 comprises a first stroke limitation means 161A in a cross-sectional view in the longitudinal axis direction L in the direction of the first sealing seat 112 and a second stroke limitation means 161B in the direction of the second sealing seat 114. In other words, the stopper 161 can comprise a larger thickness than the spacer means 160 in a cross-sectional view in the longitudinal axis direction L. In particular, in a cross-sectional view in the longitudinal axis direction L, the stopper 161 is greater by the additional extension of the first stroke limitation means 161A and the second stroke limitation means 161B than the thickness of the section of the spacer means 160 received between the first sealing means 150 and the second sealing means 152. In other words, the spacer means 160 can comprise an at least essentially T-shaped cross-section.

Here, too, the first sealing seat 112 can comprise a first seat portion 112A for receiving a contact surface 162 of the first sealing means 150 and a second seat portion 112B for receiving the first stroke limitation means 161A of the spacer means 160. In other words, the first stroke limitation means 161A of the spacer means 160 limits a stroke of the valve body 120 in the direction of the first sealing seat 112 and is designed to stop against the second seat portion 112B of the first sealing seat 112. As shown in FIG. 8, the first seat portion 112A in this case comprises an inclined shaping which corresponds essentially to the inclination of the first contact surface 162 of the first section 151 of the first sealing means 150. The second seat portion 112B of the first sealing seat 112 in this case corresponds to a wall which extends in a direction of extension which is radial relative to the longitudinal axis direction L in the direction of the inflow opening 130.

In contrast to the spacer means 160 according to the embodiment shown in FIG. 6, in the embodiment shown in FIG. 8, the spacer means 160 extends as far as the valve body 120. In other words, the spacer means 160 makes contact with the valve body 120.

In this case, the first sealing means 150 and the second sealing means 152 can be sealing means which are separated from one another.

Alternatively, however, it is also conceivable here that the first sealing means 150 and the second sealing means 152 can be designed as a one-piece integral sealing means 158 which is designed to bear against the first sealing seat 112 and at the same time to bear against the second sealing seat 114. In a longitudinal sectional view, the integral sealing means 158 is U-shaped. In this case, the first sealing means 150 corresponds to a first leg and the second sealing means 152 corresponds to a second leg, which are connected to one another via a web 153. In particular, in contrast to the embodiment shown in FIG. 6, the web 153 is arranged here on the side facing the stopper 161. In other words, the web 153 is arranged on the side of the spacer means 160 facing away from the valve body 120. The stopper 161 protrudes beyond the web 153 in the direction of extension which is radial relative to the longitudinal axis direction. In this case, the stopper 161 is not formed as a continuously annular circumferential element, but is formed so as to be interrupted along a circumferential direction which extends perpendicularly to the longitudinal axis direction L, so that a plurality of stoppers 161 extend in a circumferentially distributed manner radially from the spacer means 160. In other words, the stoppers 161, which each comprise a first stroke limitation means 161A and a second stroke limitation means 161B, extend in a direction of extension which is radial relative to the longitudinal axis direction as radial projections from the spacer means 160.

In order to prevent tilting of the valve body 120, the plurality of stoppers 161 comprises, in particular, at least three stoppers 161 which are distributed uniformly around the circumference of the spacer means 160. The regions of the spacer means 160 which lie between two adjacent stoppers 161 are injection-molded by means of the web 153 of the one-piece integral sealing means 158. The spacer means 160 can therefore be protected against the refrigerant which is present in the valve arrangement 100 and therefore affords less contact area.

During the transfer of the valve body 120 into the first sealing seat 112, the first sealing means 150 firstly comes into contact with the first seat portion 112A of the first sealing seat 112 with its contact surface 162 and is elastically deformed until the first stroke limitation means 161A of the stopper 161 makes contact with the second seat portion 112B of the first sealing seat 112 and prevents further movement of the valve body 120.

Even if this is not explicitly shown in FIG. 8, the second sealing seat 114 analogously comprises a first seat portion 114A for receiving a contact surface 164 of the second sealing means 152 and a second seat portion 114B for receiving the second stroke limitation means 161B of the stopper 161. The features described above with respect to the first sealing seat 112 and the first sealing means 150 also apply correspondingly to the second sealing seat 114 and the second sealing means 152.

It should be noted that the features of the invention which are described with respect to individual embodiments or variants, such as, for example, the type and configuration of the individual components and the exact dimensioning and spatial arrangement thereof, can also be present in other embodiments, unless stated otherwise or prohibited for technical reasons. Moreover, all features of individual embodiments described in combination do not have to be necessarily realized in a particular embodiment.

### LIST OF REFERENCE NUMERALS

100 Proportional valve arrangement
102 Rotor
103 Containment shroud
104 Stator
105 Valve body chamber
112 First sealing seat
112A First seat portion of the first sealing seat
112B Second seat portion of the first sealing seat
114 Second sealing seat
114A First seat portion of the second sealing seat
114B Second seat portion of the second sealing seat
120 Valve body
130 Inflow opening
135 First outflow opening
140 Second outflow opening
141 First flow path
142 Second flow path
150 First sealant
151 First portion of the first sealant
152 Second sealant
153 First portion of the second sealant
155 First retaining means
157 Second retaining means
158 Integral sealant
160 Spacer means
161 Stopper
161A First stroke limitation means
161B Second stroke limitation means
162 Contact surface of the first portion of the first sealant
164 Contact surface of the first portion of the second sealant
165A First sealant reservoir
165B Second sealant reservoir
170 Pressure bypass
L longitudinal axis direction
I inclination angle

1. A proportional valve arrangement for refrigerant, comprising:
a valve body chamber comprising an inflow opening, a first outflow opening and a second outflow opening,
a valve body configured to be transferable in the valve body chamber in a longitudinal axis direction (L) between a first sealing seat and a second sealing seat,
wherein the valve body opens a first flow path from the inflow opening to the first outflow opening when the valve body bears against the first sealing seat, and opens a second flow path from the inflow opening to the second outflow opening when the valve body bears against the second sealing seat, and
wherein the valve body comprises a first sealing means configured to bear against the first sealing seat, and a second sealing means configured to bear against the second sealing seat.

2. The proportional valve arrangement according to claim 1, wherein the first sealing means and the second sealing means each comprise plastic or an elastomer.

3. The proportional valve arrangement according to claim 1, wherein the first sealing means comprises a first portion configured to bear against the first sealing seat, and/or wherein the second sealing means comprises a second portion configured to bear against the second sealing seat.

4. The proportional valve arrangement according to claim 3, wherein the first sealing means and the second sealing means are arranged tensioned in the longitudinal axis direction (L).

5. The proportional valve arrangement according to claim 1, wherein the valve body comprises a first holding means and a second holding means, wherein the first sealing means and the second sealing means are arranged in the longitudinal axis direction (L) between the first holding means and the second holding means, and wherein the first holding means and/or the second holding means is configured to be displaceable in the longitudinal axis direction (L).

6. The proportional valve arrangement according to claim 1, further comprising a spacer means arranged between the first sealing means and the second sealing means, wherein the spacer means is configured to stop the valve body against the first sealing seat and the second sealing seat.

7. The proportional valve arrangement according to claim 1, wherein the first sealing means and the second sealing means are configured as a one-piece integral sealing means.

8. The proportional valve arrangement according to claim 7, wherein the one-piece integral sealing means is U-shaped in a longitudinal sectional view and at least partially surrounds the spacer means.

9. The proportional valve arrangement according to claim 6, wherein the spacer means comprises a stopper projecting beyond the first sealing means and the second sealing means in a direction of extent radial to the longitudinal axis direction (L).

10. The proportional valve arrangement according to claim 9, wherein the spacer means and the stopper are configured in one piece.

11. The proportional valve arrangement according to claim 9, wherein the stopper comprises a first stroke limitation means extending in the direction of the first sealing seat and a second stroke limitation means extending in the direction of the second sealing seat.

12. The proportional valve arrangement according to claim 1, wherein a first contact surface of the first portion of the first sealing means with the first sealing seat and a second contact surface of the second portion of the second sealing means with the second sealing seat are inclined with respect to the longitudinal axis direction (L).

13. The proportional valve arrangement according to claim 12, wherein an inclination angle (I) of the first contact surface with respect to the longitudinal axis direction (L) lies in a range greater than 10° and less than 45° and an inclination angle (I) of the second contact surface with respect to the longitudinal axis direction (L) lies in a range greater than 10° and less than 45°.

14. The proportional valve arrangement according to claim 1, wherein the first sealing seat and the second sealing seat each comprise a first seat portion for receiving, respectively, the first contact surface of the first sealing means and the second contact surface of the second sealing means and a second seat portion for receiving the stopper of the spacer means.

15. The proportional valve arrangement according to claim 14, wherein the first seat portion of the first sealing seat and the first seat portion of the second sealing seat each form a convex contour on the first or second sealing seat.

16. The proportional valve arrangement according to claim 1, wherein the spacer means each comprises a sealing means reservoir on a first side facing the first sealing seat and on a second side facing the second sealing seat in a direction radial to the longitudinal axis direction (L), within the stopper, on a position corresponding to the first or second sealing seat.

17. The proportional valve arrangement according to claim 1, further comprising a pressure bypass connecting the first outflow opening to the valve body chamber when the valve body bears against the second sealing seat, wherein the pressure bypass comprises a connecting line through the valve body.
